(19) United States
(12) Patent Application Publication
(10) Pub. No.: US 2008/0312926 A1
(43) Pub. Date: Dec. 18, 2008

(54) Automatic Text-Independent, Language-Independent Speaker Voice-Print Creation and Speaker Recognition

(76) Inventors: Claudio Vair, Torino (IT); Daniele Colibro, Torino (IT); Luciano Fissore, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/920,849

(22) PCT Filed: May 24, 2005
(86) PCT No.: PCT/IT2005/000296

§ 371 Date: May 13, 2008

(51) Int. Cl. H04N 9/64

(52) U.S. Cl. 704/249; 704/E17.001

(57) ABSTRACT

An automatic dual-step, text independent, language-independent speaker voice-print creation and speaker recognition method, wherein a neural network-based technique is used in a first step and a Markov model-based technique is used in a second step. In particular, the first step uses a neural network-based technique for decoding the content of what is uttered by the speaker in terms of language independent acoustic-phonetic classes, wherein the second step uses the sequence of language-independent acoustic-phonetic classes from the first step and employs a Markov model-based technique for creating the speaker voice-print and for recognizing the speaker. The combination of the two steps enables improvement in the accuracy and efficiency of the speaker voice-print creation and of the speaker recognition, without setting any constraints on the lexical content of the speaker utterance and on the language thereof.

### TECHNICAL FIELD OF THE INVENTION

The present invention relates in general to automatic speaker recognition, and in particular to an automatic text-independent, language-independent speaker voice-print creation and speaker recognition.

### BACKGROUND ART

As is known, a speaker recognition system is a device capable of extracting, storing and comparing biometric characteristics of the human voice, and of performing, in addition to a recognition function, also a training procedure, which enables storage of the voice biometric characteristics of a speaker in appropriate models, referred to as voice-prints. The training procedure must be carried out for all the speakers concerned and is preliminary to the subsequent recognition steps, during which the parameters extracted from an unknown voice signal are compared with those of the voice-prints for producing the recognition result.

Two specific applications of a speaker recognition system are speaker verification and speaker identification. In the case of speaker verification, the purpose of recognition is to confirm or refuse a declaration of identity associated to the uttering of a sentence or word. The system must, that is, answer the question: “Is the speaker the person he says he is?” In the case of speaker identification, the purpose of recognition is to identify, from a finite set of speakers whose voice-prints are available, the one to which an unknown voice corresponds. The purpose of the system is in this case to answer the question: “Who does the voice belong to?” In the case where the answer may be “None of the known speakers”, identification is done on an open set; otherwise, identification is done on a closed set. When reference is made to speaker recognition, it is generally meant both the applications of verification and identification.

A further classification of speaker recognition systems regards the lexical content usable by the recognition system: in this case, we have to do with text-dependent speaker recognition or text-independent speaker recognition. The text-dependent case requires that the lexical content used for verification or identification should correspond to what is uttered for the creation of the voice-print: this situation is typical of voice authentication systems, in which the word or sentence uttered assumes, to all purposes and effects, the connotation of a voice password. The text-independent case does not, instead, set any constraint between the lexical content of training and that of recognition.

Hidden Markov Models (HMMs) are a classic technology used for speech and speaker recognition. In general, a model of this type consists of a certain number of states connected by transition arcs. Associated to a transition is a probability of passing from the origin state to the destination one. In addition, each state can emit symbols from a finite alphabet according to a given probability distribution. A probability density is associated to each state, which probability density is defined on a vector of parameters extracted from the voice signal at fixed time quanta (for example, every 10 ms), said vector being referred to also as observation vector. The symbols emitted, on the basis of the probability density associated to the state, are hence the infinite possible parameter vectors. This probability density is given by a mixture of Gaussians in the multidimensional space of the parameter vectors.

In the case of application of Hidden Markov Models to speaker recognition, in addition to the models of acoustic-phonetic units with a number of states described previously; frequently recourse is had to the so-called Gaussian Mixture Models (GMMs). A GMM is a Markov model with a single state and with a transition arc towards itself. Generally, the probability density of GMMs is constituted by a mixture of Gaussians with cardinality of the order of some thousands of Gaussians. In the case of text-independent speaker recognition, GMMs represent the category of models most widely used in the prior art.

Speaker recognition is performed by creating, during the training step, models adapted to the voice of the speakers concerned and by evaluating the probability that they generate based on vectors of parameters extracted from an unknown voice sample, during the recognition step. The models adapted to the individual speakers, which may be either HMMs of acoustic-phonetic units or GMMs, are referred to as voice-prints. A description of voice-print training techniques which is applied to GMMs and of their use for speaker recognition is provided in Reynolds, D. A. et al., Speaker verification using adapted Gaussian mixture models, Digital Signal Processing 10 (2000), pp. 19-41.

Another technology known in the literature and widely used in automatic speech recognition is that of Artificial Neural Networks (ANNs), which are a parallel processing structure that reproduces, in a very simplified form, the organization of the cerebral cortex. A neural network is constituted by numerous processing units, referred to as neurons, which are densely interconnected by means of connections of various intensity referred to as synapses or interconnection weights. The neurons are in general arranged according to a structure with various levels, namely, an input level, one or more intermediate levels, and an output level. Starting from the input units, to which the signal to be treated is supplied, processing propagates to the subsequent levels of the network until it reaches the output units, which supply the result.

The neural network is used for estimating the probability of an acoustic-phonetic unit given the parametric representation of a portion of input voice signal. To determine the sequence of acoustic-phonetic units with maximum likelihood, dynamic programming algorithms are commonly used. The most commonly adopted form for speech recognition is that of Hybrid Hidden Markov Models/Artificial Neural Networks (Hybrid HMM/ANNs), in which the neural network is used for estimating the a posteriori likelihood of emission of the states of the underlying Markov chain.

A speaker identification using unsupervised speech models and large vocabulary continuous speech recognition is described in Newman, M. et al., Speaker Verification through Large Vocabulary Continuous Speech Recognition, in Proc. of the International Conference on Spoken Language Processing, pp. 2419-2422, Philadelphia, USA (October 1996), and in U.S. Pat. No. 5,946,654, wherein a speech model is produced for use in determining whether a speaker, associated with the speech model, produced an unidentified speech sample. First a sample of speech of a particular speaker is obtained. Next, the contents of the sample of speech are identified using a large vocabulary continuous speech recognition (LVCSR). Finally, a speech model associated with the particular speaker is produced using the sample of speech and the identified contents thereof. The speech model is produced without using an external mechanism to monitor the accuracy with which the contents were identified.

The Applicant has observed that the use of a LVCSR makes the recognition system language-dependent, and hence it is capable of operating exclusively on speakers of a given language. Any extension to new languages is a highly demanding operation, which requires availability of large voice and linguistic databases for the training of the necessary acoustic and language models. In particular, in speaker recognition systems used for tapping purposes, the language of the speaker cannot be known a priori, and therefore employing a system like this with speakers of languages that are not envisaged certainly involves a degradation in accuracy due both to the lack of lexical coverage and to the lack of phonetic coverage, since different languages may employ phonetic alphabets that do not completely correspond as well as employing, of course, different words. Also from the point of view of efficiency the use of a large-vocabulary continuous-speech recognition is at a disadvantage because the computation power and the memory required for recognizing tens or hundreds of thousands of words are certainly not negligible.

A prompt-based speaker recognition system which combines a speaker-independent speech recognition and a text-dependent speaker recognition is described in U.S. Pat. No. 6,094,632. A speaker recognition device for judging whether or not an unknown speaker is an authentic registered speaker himself/herself executes text verification using speaker independent speech recognition and speaker verification by comparison with a reference pattern of a password of a registered speaker. A presentation section instructs the unknown speaker to input an ID and utter a specified text designated by a text generation section and a password. The text verification of the specified text is executed by a text verification section, and the speaker verification of the password is executed by a similarity calculation section. The judgment section judges that the unknown speaker is the authentic registered speaker himself/herself if both the results of the text verification and the speaker verification are affirmative. The text verification is executed using a set of speaker independent reference patterns, and the speaker verification is executed using speaker reference patterns of passwords of registered speakers, thereby storage capacity for storing reference patterns for verification can be considerably reduced. Preferably, speaker identity verification between the specified text and the password is executed.

An example of text-dependent speaker recognition system combining an Hybrid HMM/ANN model for verifying the lexical content of a voice password defined by the user, and GMMs for speaker verification, is provided in BenZeghiba, M. F. et al., User-Customized Password Speaker Verification Base on HMM/ANN and GMM Models, in Proc. of the International Conference on Spoken Language Processing, pp. 1325-1328, Denver, Colo. (September 2002) and BenZeghiba, M. F. et al., Hybrid HMM/ANN and GMM combination for User-Customized Password Speaker Verification, in Proc. of the IEEE International Conference on Acoustics, Speech and Signal Processing, pp. II-225-228, Hong-Kong, China (April, 2003).

In BenZeghiba, M. F. et al., Confidence Measures in Multiple Pronunciation Modeling for Speaker Verification, in Proc. of the IEEE International Conference on Acoustics, Speech and Signal Processing, pp. I-389-392, Montreal, Quebec, Canada (May, 2004) there is describes a user-customized password speaker verification system, where a speaker-independent hybrid HMM/MLP (Multi-Layer Perceptron Neural Network) system is used to infer the pronunciation of each utterance in the enrollment data. Then, a speaker-dependent model is created that best represents the lexical content of the password.

Combination of hybrid neural networks with Markov models has also been used for speech recognition, as described in U.S. Pat. No. 6,185,528, applied to the recognition of isolated words, with a large vocabulary. The technique described enables improvement in the accuracy of recognition and also enables a factor of certainty to be obtained for deciding whether to request confirmation on what is recognized.

The main problem affecting the above-described speaker recognition systems, specifically those employing two subsequent recognition steps, is that they are either text-dependent or language-dependent, and this limitation adversely affects effectiveness and efficiency of these systems.

### OBJECT AND SUMMARY OF THE INVENTION

The Applicant has found that this problem can be solved by creating voice-prints based on language-independent acoustic-phonetic classes that represent the set of the classes of the sounds that can be produced by the human vocal apparatus, irrespective of the language and may be considered universal phonetic classes. The language-independent acoustic-phonetic classes may for example include front, central, and back vowels, the diphthongs, the semi-vowels, and the nasal, plosive, fricative and affricate consonants.

The object of the present invention is therefore to provide an effective and efficient text-independent and language-independent voice-print creation and speaker recognition (verification or identification).

This object is achieved by the present invention in that it relates to a speaker voice-print creation method, as claimed in claim 1, to a speaker verification method, as claimed in claim 9, to a speaker identification method, as claimed in claim 18, to a speaker recognition system, as claimed in any one of the claims 21 to 23, and to a computer program product, as claimed in any one of the claims 24 to 26.

The present invention achieves the aforementioned object by carrying out two sequential recognition steps, the first one using neural-network techniques and the second one using Markov model techniques. In particular, the first step uses a Hybrid HMM/ANN model for decoding the content of what is uttered by speakers in terms of sequence of language-independent acoustic-phonetic classes contained in the voice sample and detecting its temporal collocation, whereas the second step exploits the results of the first step for associating the parameter vectors, derived from the voice signal, to the classes detected and in particular uses the HMM acoustic models of the language-independent acoustic-phonetic classes obtained from the first step for voice-prints creation and for speaker recognition. The combination of the two steps enables improvement in the accuracy and efficiency of the process of creation of the voice-prints and of speaker recognition, without setting any constraints on the lexical content of the messages uttered and on the language thereof.

During creation of the voice-prints, the association is used for collecting the parameter vectors that contribute to training of the speaker-dependent model of each language-independent acoustic-phonetic class, whereas during speaker recognition, the parameter vectors associated to a class are evaluated with the corresponding HMM acoustic model to produce the probability of recognition.

Even though the language-independent acoustic-phonetic classes are not adequate for speech recognition in so far as they have an excessively rough detail and do not model well the peculiarities regarding the sets of phonemes used for a specific language, they present the ideal detail for text-independent and language-independent speaker recognition. The definition of the classes takes into account both the mechanisms of production of the voice and measurements on the spectral distance detected on voice samples of various speakers in various languages. The number of languages required for ensuring a good coverage for all classes can be of the order of tens, chosen appropriately between the various language stocks. The use of language-independent acoustic-phonetic classes is optimal for efficient and precise decoding which can be obtained with the neural network technique, which operates in discriminative mode and so offers a high decoding quality and a reduced burden in terms of calculation given the restricted number of classes necessary to the system. In addition, no lexical information is required, which is difficult and costly to obtain and which implies, in effect, language dependence.

### BRIEF DESCRIPTION OF THE DRAWINGS

For a better understanding of the present invention, a preferred embodiment, which is intended purely by way of example and is not to be construed as limiting, will now be described with reference to the attached drawings, wherein:

FIG. 1 shows a block diagram of a language-independent acoustic-phonetic class decoding system;

FIG. 2 shows a block diagram of a speaker voice-print creation system based on the decoded sequence of language-independent acoustic-phonetic classes;

FIG. 3 shows an adaptation procedure of original acoustic models to a speaker based on the language-independent acoustic-phonetic classes;

FIG. 4 shows a block diagram of a speaker verification system operating based on the decoded sequence of language-independent acoustic-phonetic classes;

FIG. 5 shows a computation step of a verification score of the system;

FIG. 6 shows a block diagram of a speaker identification system operating based on the decoded sequence of language-independent acoustic-phonetic classes; and

FIG. 7 shows a block diagram of a maximum-likelihood voice-print identification module based on the decoded sequence of language-independent acoustic-phonetic classes.

### DETAILED DESCRIPTION OF PREFERRED EMBODIMENTS OF THE INVENTION

The following discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein and defined in the attached claims.

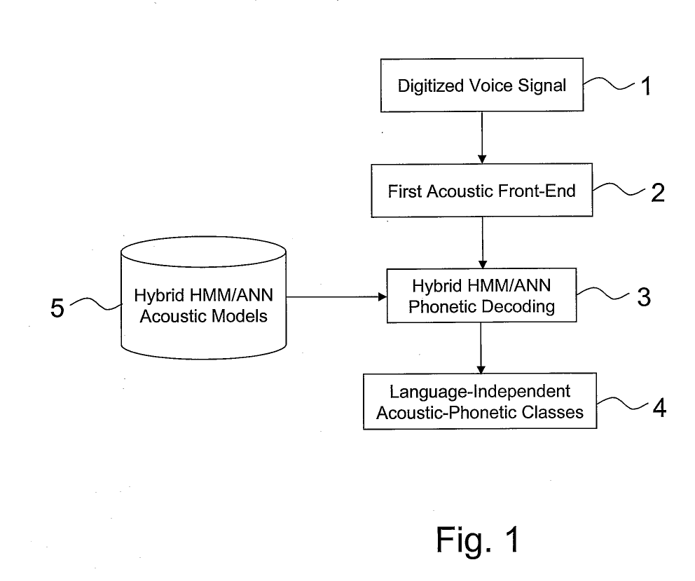

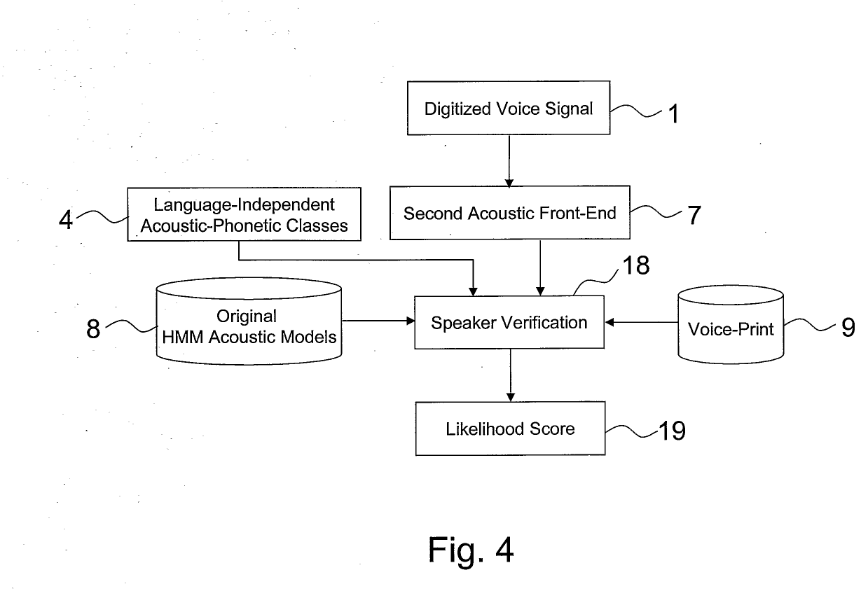

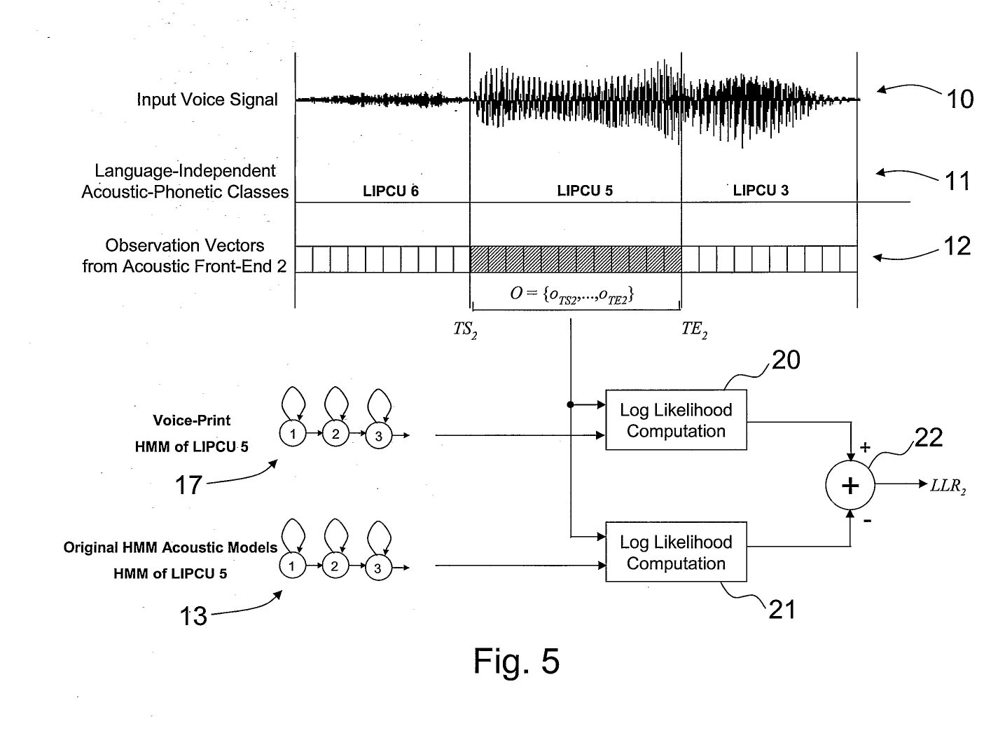

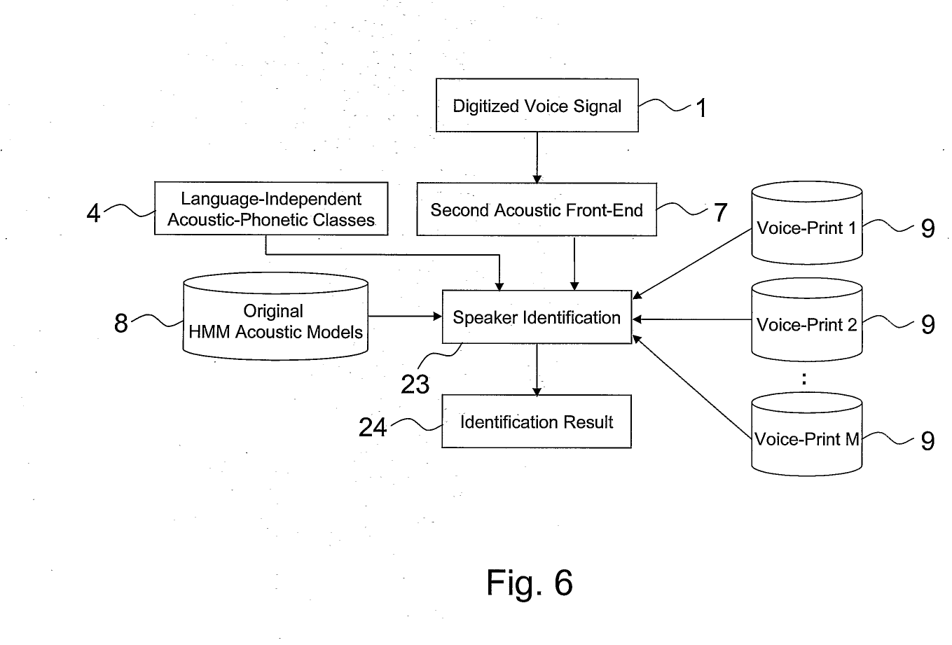

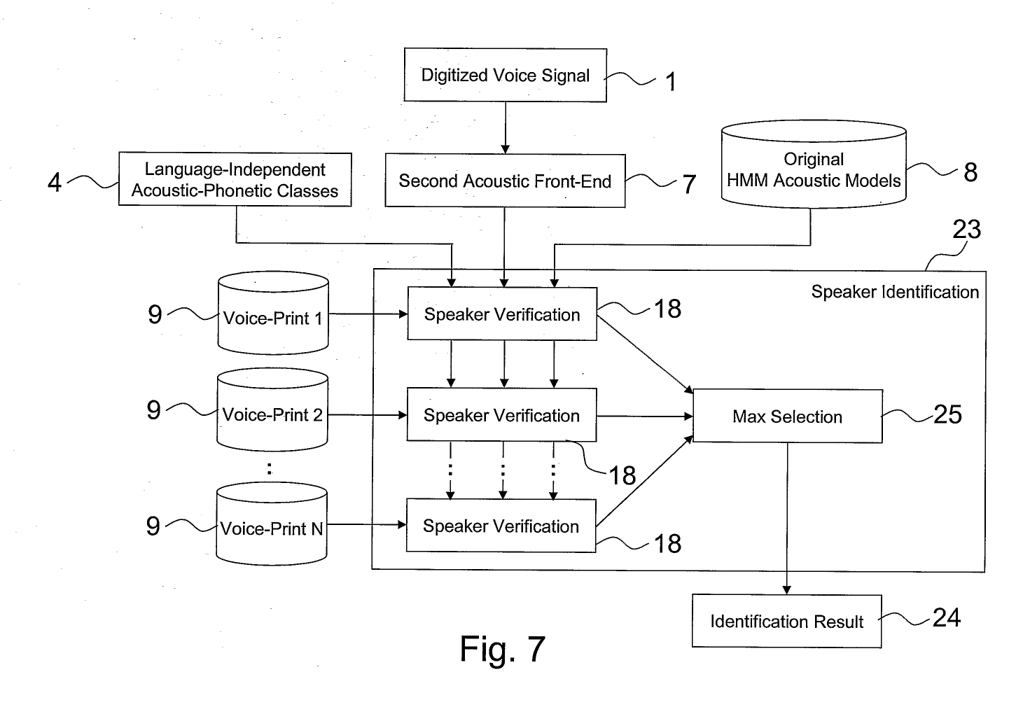

In addition, the present invention is implemented by means of a computer program product including software code portions for implementing, when the computer program product is loaded in a memory of the processing system and run on the processing system, a speaker voice-print creation system, as described hereinafter with reference to FIGS. 1-3, a speaker verification system, as described hereinafter with reference to FIGS. 4 and 5, and a speaker identification system, as described hereinafter with reference to FIGS. 6 and 7.

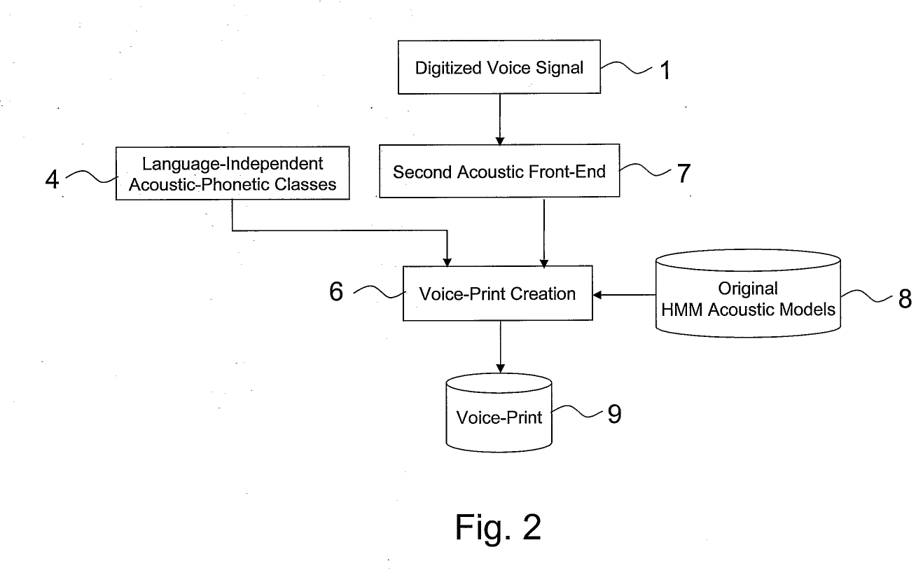

FIGS. 1 and 2 show block diagrams of a dual-stage speaker voice-print creation system according to the present invention. In particular, FIG. 1 shows a block diagram of a language-independent acoustic-phonetic class decoding stage, whereas FIG. 2 shows a block diagram of a speaker voice-print creation stage operating based on the decoded sequence of language-independent acoustic-phonetic classes.

With reference to FIG. 1, a digitized input voice signal 1, representing an utterance of a speaker, is provided to a first acoustic front-end 2, which processes it and provides, at fixed time frames, typically 10 ms, an observation vector, which is a compact vector representation of the information content of the speech.

In a preferred embodiment, each observation vector from the first acoustic front-end 2 is formed by Mel-Frequency Cepstrum Coefficients (MFCC) parameters. The order of the bank of filters and of the DCT (Discrete Cosine Transform), used in the generation of the MFCC parameters for phonetic decoding can be 13. In addition, each observation vector may conveniently includes also the first and second time derivatives of each parameter.

A hybrid HMM/ANN phonetic decoder 3 then processes the observation vectors from the first acoustic front-end 2 and provides a sequence of language-independent acoustic-phonetic classes 4 with maximum likelihood, based on the observation vectors and stored hybrid HMM/ANN acoustic models 5. The hybrid HMM/ANN phonetic decoder 3 is a particular automatic voice decoder which operates independently of any linguistic and lexical information, which is based upon hybrid HMM/ANN acoustic models, and which implements dynamic programming algorithms that perform the dynamic time-warping and enable the sequence of acoustic-phonetic classes and the corresponding temporal collocation to be obtained, maximizing the likelihood between the acoustic models and the observation vectors. For a detailed description of the dynamic programming algorithms reference may be made to Huang X., Acero A., and Hon H. W., Spoken Language Processing: A Guide to Theory Algorithm, and System Development, Prentice Hall, Chapter 8, pages 377-413, 2001.

Language-independent acoustic-phonetic classes 4 represent the set of the classes of the sounds that can be produced by the human vocal apparatus, which are language-independent and may be considered universal phonetic classes capable of modeling the content of any vocal message. Even though the language-independent acoustic-phonetic classes are not adequate for speech recognition in so far as they have an excessively rough detail and do not model well the peculiarities regarding the set of phonemes used for a specific language, they present the ideal detail for text-independent and language-independent speaker recognition. The definition of the classes takes into account both the mechanisms of production of the voice and those of measurements on the spectral distance detected on voice samples of various speakers in various languages. The number of languages required for ensuring a good coverage for all classes can be of the order of tens, chosen appropriately between the various language stocks. In a particular embodiment, the language-independent acoustic-phonetic classes usable for speaker recognition may include front, central and back vowels, diphthongs, semi-vowels, nasal, plosive, fricative and affricate consonants.

The sequence of language-independent acoustic-phonetic classes 4 from the hybrid HMM/ANN phonetic decoder 3 are used to create a speaker voice-print, as shown in FIG. 2. In particular, the sequence of language-independent acoustic-phonetic classes 4 and the corresponding temporal collocations are provided to a voice-print creation module 6, which also receives observation vectors from a second acoustic front-end 7 which is aimed at producing parameters adapted for speaker recognition based on the digitized input voice signal 1.

The voice-print creation module 6 uses the observation vectors from the second acoustic front-end 7, associated to a specific language-independent acoustic-phonetic class provided by the hybrid HMM/ANN phonetic decoder 3, for adapting a corresponding original HMM acoustic model 8 to the speaker characteristics. The set of the adapted HMM acoustic models 8 of the acoustic-phonetic classes forms the voice-print 9 of the speaker to whom the input voice signal belongs.

In a preferred embodiment, each observation vector from the second acoustic front-end 7 is formed by MFCC parameters of order 19, extended with their first time derivatives.

In a particular embodiment, the voice-print creation module 6 implements an adaptation technique known in the literature as MAP (Maximum A Posteriori) adaptation, and operates starting from a set of original HMM acoustic models 8, being each model representative of a language-independent acoustic-phonetic class. The number of language-independent acoustic-phonetic classes represented by original acoustic models HMM can be equal or lower then the number of language-independent acoustic-phonetic classes generated by the hybrid HMM/ANN phonetic decoder. In case different language-independent acoustic-phonetic classes are chosen in the first phonetic decoding step which uses the hybrid acoustic model HMM/ANN and in the subsequent step of creating the speaker voice-print or speaker recognition, a one-to-one correspondence function should exist which associates each language-independent acoustic-phonetic class adopted by the hybrid HMM/ANN decoder to a single language-independent acoustic-phonetic class, represented by the corresponding original HMM acoustic model.

In a preferred embodiment hereinafter described the language-independent acoustic-phonetic classes represented by the hybrid HMM/ANN acoustic model are the same as those represented by the original HMM acoustic model, with 1:1 correspondence.

These original HMM acoustic models 8 are trained on a variety of speakers and represent the general model of the “world”, also known as universal background model. All of the voice-prints are derived from the universal background model by means of its adaptation to the characteristics of each speaker. For a detailed description of the MAP adaptation technique, reference may be made to Lee, C.-H. and Gauvain, J.-L., Adaptive Learning in Acoustic and Language Modeling, in New Advances and Trends in Speech Recognition and Coding, NATO ASI Series F, A. Rubio Editor, Springer-Verlag, pages 14-31, 1995.

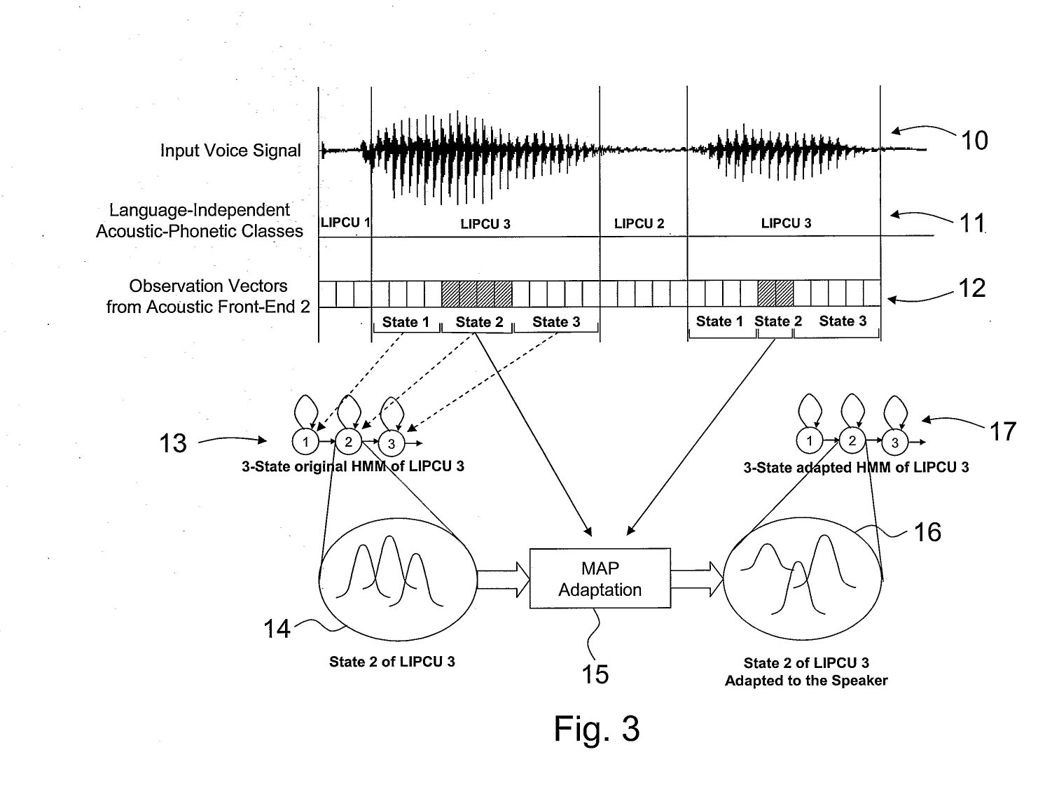

FIG. 3 shows in greater detail the adaptation procedure of the original HMM acoustic models 8 to the speaker. The voice signal from a speaker S, referenced by 10, is decoded by means of the Hybrid HMM/ANN phonetic decoder 3, which provides a language-independent acoustic-phonetic class decoding in terms of Language Independent Phonetic Class Units (LIPCUs). The decoded LIPCUs, referenced by 11, are temporally aligned to corresponding temporal segments of the input voice signal 10 and to the corresponding observation vectors, referenced by 12, provided by the second acoustic front-end 7. In this way, each temporal segment of the input voice signal is associated with a corresponding language-independent acoustic-phonetic class (which may also be associated with other temporal segments) and a corresponding set of observation vectors.

By means of dynamic programming techniques, which perform dynamic time-warping, the set of observation vectors associated with each LIPCU is further divided into a number of sub-sets of observation vectors equal to the number of states of the original HMM acoustic model of the corresponding LIPCU, and each sub-set is associated with a corresponding state of the original HMM acoustic model of the corresponding LIPCU. By way of example, FIG. 3 also shows the original HMM acoustic model, referenced by 13, of the LIPCU 3, which original HMM acoustic model is constituted by a three-state left-right automaton. The observation vectors into the sub-sets concur to the MAP adaptation of the corresponding acoustic states. In particular, with dashed blocks in FIG. 3 there are depicted the observation vectors attributed, by way of example, to the state 2, referenced by 14, of the LIPCU 3 and used for its MAP adaptation, referenced by 15, thus providing an adapted states 2, referenced by 16, of an adapted HMM acoustic model, referenced by 17, of the LIPCU 3. The set of the HMM acoustic models of the LIPCUs, adapted to the voice of the speaker S, constitutes the speaker voice-print 9.

FIG. 4 shows a block diagram of a speaker verification system. As in the case of the creation of the voice-prints, a speaker verification module 18 receives the sequence of language-independent acoustic-phonetic classes 4, the observation vectors from the second acoustic front-end 7, the original HMM acoustic models 8, and the speaker voice-print 9 with which it is desired to verify the voice contained in the digitized input voice signal 1, and provides a speaker verification result 19 in terms of a verification score.

In a particular implementation, the verification score is computed as the likelihood ratio between the probability that the voice belongs to the speaker to whom the voice-print corresponds and the probability that the voice does not belong to the speaker, i.e.:

$$\frac{Pr ( {Λ}_{s} \vert O )}{Pr ( {Λ}_{\overline{s}} \vert O )}$$

where Λ_{S} represents the model of the speaker S, Λ _{S̅} the complement of the model of the speaker and O={O₁, . . . , O_{T}} the set of the observation vectors extracted from the voice signal for the frames from 1 to T.

Applying the Bayes' theorem and neglecting the a priori probability that the voice belongs to the speaker or not (assumed as being constant), the likelihood ratio can be rewritten in logarithmic form, as follows:

LLR=log p(O|Λ_{S})−log p(O|Λ _{S̅})

where LLR is the Log Likelihood Ratio and p(O|Λ_{S}) is the likelihood that the observation vectors O={O₁, . . . , O_{T}} have been generated by the model of the speaker rather than by its complement p(O|Λ _{S̅}). In a particular embodiment, LLR represents the system verification score.

The likelihood of the utterance being of the speaker and the likelihood of the utterance not being of the speaker (i.e., the complement) are calculated employing, respectively, the speaker voice-print 9 as model of the speaker and the original HMM acoustic models 8 as complement of the model of the speaker. The two likelihoods are obtained by cumulating the terms regarding the models of the decoded language-independent acoustic-phonetic classes and averaging on the total number of frames.

The likelihood regarding the model of the speaker is hence defined by the following equation:

$$log p ( O \vert {Λ}_{s} ) = \frac{1}{T} {\sum }_{i = 1}^{N} {\sum }_{t = {TS}_{i}}^{{TE}_{i}} log p ( {o}_{t} \vert {Λ}_{{LIPCU}_{i} , S} )$$

where T is the total number of frames of the input voice signal, N is the number of decoded LIPCUs, TSᵢ and TEᵢ are the times in initial and final frames of the i-th decoded LIPCU, oₜ the observation vector at time t, and Λ_{LIPCU}_{ᵢ}_{,S} is the model for the i-th decoded LIPCU extracted from the model of the voice-print of the speaker S.

In a similar way, the likelihood regarding the complement of the model of the speaker is defined by:

$$log p ( O \vert {Λ}_{\overline{S}} ) = \frac{1}{T} {\sum }_{i = 1}^{N} {\sum }_{t = {TS}_{i}}^{{TE}_{i}} log p ( {o}_{t} \vert {Λ}_{{LIPCU}_{i} , \overline{S}} )$$

from which LLR can be calculated as:

$$LLR = \frac{1}{T} {\sum }_{i = 1}^{N} {\sum }_{t = {TS}_{i}}^{{TE}_{i}} [ log p ( {o}_{t} \vert {Λ}_{{LIPCU}_{i} , S} ) - log p ( {o}_{t} \vert {Λ}_{{LIPCU}_{i} , \overline{S}} ) ]$$

The verification decision is made by comparing LLR with a threshold value, set according to system security requirements: if LLR exceeds the threshold, the unknown voice is attributed to the speaker to whom the voice-print belongs.

FIG. 5 shows a the computation of one term of the external summation of the previous equation, regarding, in the example, the computation of the contribution to the LLR of the LIPCU 5, decoded by the Hybrid HMM/ANN phonetic decoder 3 in position 2 and with indices of initial and final frames TS₂ and TE₂. The decoding flow in terms of language-independent acoustic-phonetic classes is similar to the one illustrated in FIG. 3. The observation vectors O, provided by the second acoustic front-end 7 and aligned to the LIPCUs by the Hybrid HMM/ANN phonetic decoder 3, are used by two likelihood calculation blocks 20, 21, which operate based on the original HMM acoustic models of the decoded LIPCUs and, by means of dynamic programming algorithms, provide the likelihood that the observation vectors have been produced by the respective models. The two likelihood calculation blocks 20, 21 use the adapted HMM acoustic models of the voice-print 9 and the original HMM acoustic models 8, used as complement to the model of the speaker. The two resultant likelihoods are hence subtracted from one another in a subtractor 22 to obtain the verification score LLR₂ regarding the second decoded LIPCU.

FIG. 6 shows a block diagram of a speaker identification system. The block diagram is similar to the one shown in FIG. 4 relating to the speaker verification. In particular, a speaker identification block 23 receives the sequence of language-independent acoustic-phonetic classes 4, the observation vectors from the second acoustic front-end 7, the original HMM acoustic models 8, and a number of speaker voice-prints 9 among which it is desired to identify the voice contained in the digitized input voice signal 1, and provides a speaker identification result 24.

The purpose of the identification is to choose the voice-print that generates the maximum likelihood with respect to the input voice signal. A possible embodiment of the speaker identification module 23 is shown in FIG. 7, where identification is achieved by performing a number of speaker verifications, one for each voice-print 9 that is candidate for identification, through a corresponding number of speaker verification modules 18, each providing a corresponding verification score in terms of LLR. The verification scores are then compared in a maximum selection block 25, and the speaker identified is chosen as the one that obtains the maximum verification score. If it is a matter of identification in an open set, the score of the best speaker is once again verified with respect to a threshold set according to the application requirements for deciding whether the attribution is or is not to be accepted.

Finally, it is clear that numerous modifications and variants can be made to the present invention, all falling within the scope of the invention, as defined in the appended claims.

In particular, the two acoustic front-ends used for the generation of the observation vectors derived from the voice signal as well as the parameters forming the observation vectors may be different than those previously described. For example, other parameters derived from a spectral analysis may be used, such as Perceptual Linear Prediction (PLP) or RelAtive SpecTrAl Technique-Perceptual Linear Prediction (RASTA-PLP) parameters, or parameters generated by a time/frequency analysis, such as Wavelet parameters and their combinations. Also the number of the basic parameters forming the observation vectors may differ according to the different embodiments of the invention, and for example the basic parameters may be enriched with their first and second time derivatives. In addition it is possible to group together one or more observation vectors that are contiguous in time, each formed by the basic parameters and by the derived ones. The groupings may undergo transformations, such as Linear Discriminant Analysis or Principal Component Analysis to increase the orthogonality of the parameters and/or to reduce their number.

Besides, language-independent acoustic-phonetic classes other than those previously described may be used, provided that there is ensured a good coverage of all the families of sounds that can be produced by the human vocal apparatus. For example, reference may be made to the classifications provided by the International Phonetic Association (IPA), which group together the sounds on the basis of the site of articulation or on the basis of their production mode. Also grouping techniques based upon measurements of phonetic similarities and derived directly from the data may be taken into consideration. It is also possible to use mixed approaches that take into account both the a priori knowledge regarding the production of the sounds and the results obtained from the data.

Moreover, Markov acoustic models used by the hybrid HMM/ANN model can be used to represent language-independent acoustic-phonetic classes with a detail which is better then or equal to language-independent acoustic-phonetic classes modeled by the original HMM acoustic models, provided that exists a one-to-one correspondence function which associates each language-independent acoustic-phonetic class adopted by the hybrid HMM/ANN decoder to a single language-independent acoustic-phonetic class, represented by the corresponding original HMM acoustic model.

Moreover, the voice-prints creation module may perform types of training other than the MAP adaptation previously described, such as maximum-likelihood methods or discriminative methods.

Finally, association between observation vectors and states of an original HMM acoustic model of a LIPCU may be made in a different way than the one previously described. In particular, instead of associating to a state of an original HMM acoustic model a sub-set of the observation vectors associated to the corresponding LIPCU, a number of weights may be assigned to each observation vector in the set of observation vectors associated to the LIPCU, one for each state of the original HMM acoustic model of the LIPCU, each weight representing the contribution of the corresponding observation vector to the adaptation of the corresponding state of the original HMM acoustic model of the LIPCU.

1-26. (canceled)

27. A method for creating a voice-print of a speaker based on an input voice signal representing an utterance of said speaker, comprising:
processing said input voice signal to provide a sequence of language-independent acoustic-phonetic classes associated with corresponding temporal segments of said input voice signal, said language-independent acoustic-phonetic classes representing sounds in said utterance and being represented by respective original acoustic models;
adapting the original acoustic model of each of said language-independent acoustic-phonetic classes to the speaker, based on the temporal segment of the input voice signal associated with a language-independent acoustic-phonetic class; and
creating said voice-print based on the adapted acoustic models of said language-independent acoustic-phonetic classes.

28. The method of claim 27, wherein processing said input voice signal comprises:
carrying out a neural network-based decoding.

29. The method of claim 28, wherein said neural network-based decoding is performed by using a hybrid hidden Markov models/artificial neural networks decoder.

30. The method of claim 27, wherein said original acoustic models of said language-independent acoustic-phonetic classes are hidden Markov models.

31. The method of claim 27, wherein processing said input voice signal comprises:
extracting observation vectors from said input voice signal, each observation vector being formed by parameters extracted from the input voice signal at a fixed time frame; and
temporally aligning said observation vectors with said input voice signal so as to associate sets of observation vectors with corresponding temporal segments of the input voice signal; and
wherein adapting the original acoustic model of each of said language-independent acoustic-phonetic classes to the speaker, based on the temporal segment of the input voice signal associated with a language-independent acoustic-phonetic class comprises:
adapting the original acoustic model of each of said language-independent acoustic-phonetic classes to the speaker, based on the set of observation vectors associated with the temporal segment of the input voice signal in turn associated with the language-independent acoustic-phonetic class.

32. The method of claim 31, wherein the original acoustic model of each of said language-independent acoustic-phonetic classes is formed by a number of acoustic states, and wherein adapting the original acoustic model of each of said language-independent acoustic-phonetic classes to the speaker, based on the set of observation vectors associated with the corresponding temporal segment of the input voice signal, comprises:
associating sub-sets of observation vectors in said set of observation vectors with corresponding acoustic states of the original acoustic model of said language-independent acoustic-phonetic class; and
adapting each acoustic state of the original acoustic model of said language-independent acoustic-phonetic class to the speaker, based on the corresponding sub-set of observation vectors.

33. The method of claim 32, wherein adaptation of an original acoustic model of a language-independent acoustic-phonetic class to a speaker is performed by implementing a maximum a posteriori adaptation technique.

34. The method of claim 32, wherein association of sub-sets of observation vectors with acoustic states of said original acoustic models of said language-independent acoustic-phonetic classes is carried out by means of dynamic programming techniques which perform dynamic time-warping based on said original acoustic models.

35. A method for verifying a speaker based on a voice-print created according to claim 27, and on an input voice signal representing an utterance of said speaker, comprising:
processing said input voice signal to provide a sequence of language-independent acoustic-phonetic classes associated with corresponding temporal segments of said input voice signal; and
computing a likelihood score indicative of a probability that said utterance has been made by the same speaker as the speaker to whom said voice-print belongs, said likelihood score being computed based on said input speech signal, said original acoustic models of said language-independent acoustic-phonetic classes and the adapted acoustic models of said language-independent acoustic-phonetic classes used to create said voice-print.

36. The method of claim 35, wherein said language-independent acoustic-phonetic classes are represented by respective original acoustic models having the same topology as the original acoustic models used to create said voice-print.

37. The method of claim 35, wherein computing said likelihood score comprises:
computing first contributions to said likelihood score, one for each one of said language-independent acoustic-phonetic classes, each first contribution being computed based on a corresponding temporal segment of said input voice signal, and on the adapted acoustic model of said language-independent acoustic-phonetic class used to create said speaker voice-print;
computing second contributions to said likelihood score, one for each language-independent acoustic-phonetic class, each second contribution being computed based on a corresponding temporal segment of said input voice signal, and on the original acoustic model of said language-independent acoustic-phonetic class; and
computing said likelihood score based on said first and second contributions.

38. The method of claim 36, wherein processing said input voice signal comprises:
extracting observation vectors from said input voice signal, each observation vector being formed by parameters extracted from the input voice signal at a fixed time frame;
temporally aligning said observation vectors with said input voice signal so as to associate sets of observation vectors with corresponding temporal segments of the input voice signal;
wherein computing a first contribution to said likelihood score for each language-independent acoustic-phonetic class comprises:
computing said first contribution to said likelihood score based on a set of observation vectors associated with the language-independent acoustic-phonetic class and the adapted acoustic model of said language-independent acoustic-phonetic class used to create said speaker voice-print;
and wherein computing said second contribution to said likelihood score for each language-independent acoustic-phonetic class comprises:
computing said second contribution to said likelihood score based on the set of observation vectors associated with said language-independent acoustic-phonetic class and said original acoustic model of said language-independent acoustic-phonetic class.

39. The method of claim 35, further comprising:
verifying said speaker based on said likelihood score.

40. The method of claim 39, wherein verifying said speaker comprises:
comparing said likelihood score with a given threshold; and
verifying said speaker based on an outcome of said comparison.

41. The method of claim 35, wherein processing said input voice signal comprises:
carrying out a neural network-based decoding.

42. The method of claim 41, wherein said neural network-based decoding is performed by using a hybrid hidden Markov models/artificial neural networks decoder.

43. The method of claim 35, wherein said original acoustic models of said language-independent acoustic-phonetic classes are hidden Markov models.

44. A method for identifying a speaker based on a number of voice-prints, each created according to claim 27, and on an input voice signal, representing an utterance of said speaker, comprising:
performing a number of speaker verifications according to a method for verifying a speaker based on a voice-print created according to the method of claim 27, and on an input voice signal representing an utterance of said speaker, comprising:
processing said input voice signal to provide a sequence of language-independent acoustic-phonetic classes associated with corresponding temporal segments of said input voice signal; and
computing a likelihood score indicative of a probability that said utterance has been made by the same speaker as the speaker to whom said voice-print belongs, said likelihood score being computed based on said input speech signal, said original acoustic models of said language-independent acoustic-phonetic classes and the adapted acoustic models of said language-independent acoustic-phonetic classes used to create said voice-print, each speaker verification being based on a respective one of said voice-prints; and
identifying said speaker based on outcomes of said speaker verifications.

45. The method of claim 44, wherein each speaker verification provides a corresponding likelihood score, and identifying said speaker based on outcomes of said speaker verifications comprising:
identifying said speaker based on said likelihood scores.

46. The method of claim 45, wherein identifying said speaker based on said likelihood scores comprises:
identifying the maximum likelihood score;
comparing said maximum likelihood score with a given threshold; and
identifying said speaker based on an outcome of said comparison.

47. A speaker recognition system capable of being configured to implement a method for creating a voice-print of a speaker based on an input voice signal representing an utterance of said speaker, comprising:
processing said input voice signal to provide a sequence of language-independent acoustic-phonetic classes associated with corresponding temporal segments of said input voice signal, said language-independent acoustic-phonetic classes representing sounds in said utterance and being represented by respective original acoustic models;
adapting the original acoustic model of each of said language-independent acoustic-phonetic classes to the speaker, based on the temporal segment of the input voice signal associated with a language-independent acoustic-phonetic class; and
creating said voice-print based on the adapted acoustic models of said language-independent acoustic-phonetic classes.

48. The system of claim 47, capable of being further configured to implement a method for verifying a speaker based on a voice-print created according to the method for creating a voice-print of a speaker and on an input voice signal representing an utterance of said speaker, comprising:
processing said input voice signal to provide a sequence of language-independent acoustic-phonetic classes associated with corresponding temporal segments of said input voice signal; and
computing a likelihood score indicative of a probability that said utterance has been made by the same speaker as the speaker to whom said voice-print belongs, said likelihood score being computed based on said input speech signal, said original acoustic models of said language-independent acoustic-phonetic classes, and the adapted acoustic models of said language-independent acoustic-phonetic classes used to create said voice-print.

49. The system of claim 47, capable of being further configured to implement a method for identifying a speaker based on a number of voice-prints, each created according to the method for creating a voice-print of a speaker, and on an input voice signal, representing an utterance of said speaker, comprising:
performing a number of speaker verifications by a method for verifying a speaker based on a voice-print created according to the method for creating a voice-print of a speaker and on an input voice signal representing an utterance of said speaker, comprising:
processing said input voice signal to provide a sequence of language-independent acoustic-phonetic classes associated with corresponding temporal segments of said input voice signal; and
computing a likelihood score indicative of a probability that said utterance has been made by the same speaker as the one to whom said voice-print belongs, said likelihood score being computed based on said input speech signal, said original acoustic models of said language-independent acoustic-phonetic classes, and the adapted acoustic models of said language-independent acoustic-phonetic classes used to create said voice-print, each speaker verification being based on a respective one of said voice-prints; and
identifying said speaker based on outcomes of said speaker verifications.

50. A computer program product loadable in a memory of a processing system and comprising software code portions capable of implementing, when the computer program product is run on the processing system, a method for creating a voice-print of a speaker based on an input voice signal representing an utterance of said speaker, comprising:
processing said input voice signal to provide a sequence of language-independent acoustic-phonetic classes associated with corresponding temporal segments of said input voice signal, said language-independent acoustic-phonetic classes representing sounds in said utterance and being represented by respective original acoustic models;
adapting the original acoustic model of each of said language-independent acoustic-phonetic classes to the speaker, based on the temporal segment of the input voice signal associated with a language-independent acoustic-phonetic class; and
creating said voice-print based on the adapted acoustic models of said language-independent acoustic-phonetic classes.

51. The computer program product of claim 50, further comprising software code portions capable of implementing, when the computer program product is run on the processing system, a method for verifying a speaker based on a voice-print created according to the method for creating a voice-print of a speaker and on an input voice signal representing an utterance of said speaker, comprising:
processing said input voice signal to provide a sequence of language-independent acoustic-phonetic classes associated with corresponding temporal segments of said input voice signal; and
computing a likelihood score indicative of a probability that said utterance has been made by the same speaker as the speaker to whom said voice-print belongs, said likelihood score being computed based on said, input speech signal, said original acoustic models of said language-independent acoustic-phonetic classes, and the adapted acoustic models of said language-independent acoustic-phonetic classes used to create said voice-print.

52. The computer program product of claim 50, further comprising software code portions capable of implementing, when the computer program product is run on the processing system, a method for identifying a speaker based on a number of voice-prints, each created according to the method for creating a voice-print of a speaker, and on an input voice signal representing an utterance of said speaker, comprising:
performing a number of speaker verifications by a method for verifying a speaker based on a voice-print created according to the method for creating a voice-print of a speaker and on an input voice signal representing an utterance of said speaker, comprising:
processing said input voice signal to provide a sequence of language-independent acoustic-phonetic classes associated with corresponding temporal segments of said input voice signal; and
computing a likelihood score indicative of a probability that said utterance has been made by the same speaker as the speaker to whom said voice-print belongs, said likelihood score being computed based on said, input speech signal, said original acoustic models of said language-independent acoustic-phonetic classes, and the adapted acoustic models of said language-independent acoustic-phonetic classes used to create said voice-print, each speaker verification being based on a respective one of said voice-prints; and
identifying said speaker based on outcomes of said speaker verifications.
